(19) United States
(12) Patent Application Publication
(10) Pub. No.: US 2020/0074570 A1
(43) Pub. Date: Mar. 5, 2020

(54) METHODS AND SYSTEMS FOR MANAGING AND PREDICTING UTILITY CONSUMPTION

(71) Applicant: VALORBEC SOCIETE EN COMMANDITE, MONTREAL (CA)

(72) Inventors: JIA YUAN YU, MONTREAL (CA); MEHDI MERAI, WESTMOUNT (CA)

(21) Appl. No.: 16/465,806

(22) PCT Filed: Dec. 4, 2017
(86) PCT No.: PCT/CA2017/000259

§ 371 Date: May 31, 2019

Related U.S. Application Data
(60) Provisional application No. 62/429,261, filed on Dec. 2, 2016.

(51) Int. Cl. G06Q 50/06; G06Q 10/04; G06K 9/62; G06N 20/00

(52) U.S. Cl. CPC G06Q 50/06; G06N 20/00; G06K 9/6256; G06Q 10/04

(57) ABSTRACT

A joint utility predictor and controller (JUPAC) system would allow a utility such as an energy supplier and its consumers to better predict electricity grid activity and then, optimize its energy production, management, distribution, and consumption. The more accurate the prediction the more positive its economic and environmental impacts will be. A JUPAC system at a consumer collects ambient parameters, user patterns, and energy usage before by exploiting an embedded machine learning algorithm it predicts the consumer's future consumption This prediction may be recurrently transmitted to the energy supplier as a formatted commitment then, in a second time, the same device will try to respect this commitment by adjusting, wisely, the user appliances and heating—ventilation and air conditioning. As a result, an energy supplier can crowd-source the global energy demand by aggregating highly detailed individual consumption commitments as well as allowing consumers to manage consumption against pricing—power tariffs.

### CROSS-REFERENCE TO RELATED APPLICATIONS

This application claims priority as a 371 National Phase Application of PCT/CA2017/000,259 entitled “Methods and Systems for Managing and Predicting Utility Consumption” filed Dec. 4, 2017 which itself claims priority from U.S. Provisional Patent Application 62/429,261 entitled “Methods and Systems for Managing and Predicting Utility Consumption” filed Dec. 2, 2016, the entire contents of each being incorporated herein by reference.

### FIELD OF THE INVENTION

This invention relates to managing and predicting a utility and more particularly to exploiting a joint utility predictor and controller for predicting a utility requirement, optionally transmitting the utility requirement to a utility provider, and managing consumption of the utility.

### BACKGROUND OF THE INVENTION

Forecasting accurate utility consumption such as electricity, gas, and water or waste generation is a challenge. However, failure to predict accurately can lead to insufficient supply and penalties for excess consumption/generation. Consider, electricity for example, then in order to perform this task, electricity suppliers today are using aggregate prediction due the lack of information about individual electricity usage and behavior. However, if they could predict energy consumption at the scale of the individual service subscriber and then aggregate this, they could in principle manage more effectively their energy distribution and optimize their energy production (by using more renewable energy for example).

Accordingly, it would be beneficial to provide a system that can jointly predict, e.g. a consumer's energy consumption, and at the same time provide management, e.g. by adjusting the consumer's appliances and its Heating Ventilation and Air Conditioning (HVAC) in order to maximize the fit with the performed prediction where significant deviations from plan or consumptions above certain thresholds lead to increased costs. Beneficially, with such a system the predicted individual usage details can be transmitted to the energy supplier as a commitment and in a structured format that can processed automatically. The energy consumption commitment will include a highly detailed prediction performed depending on the frequency that the energy supplier desires. This process can be performed without impairing the privacy of the user given the fact that the individual energy usage will be locally performed, and the commitment will include only timely aggregated energy consumption prediction. The energy supplier will therefore crowd source all predicted data coming from individual commitments to build an accurate and detailed energy demand prediction.

Such a system may then allow management of the utility consumption, for example, against the prediction where there is a cost impact to the user of exceeding either predicted consumption within one or more timescales such as hourly or daily timescales or where tariffs vary according to time of day to offset controllable consumption to lower tariff periods. Accordingly, such a joint electricity predictor and controller for a utility may contribute to the emergence of a new economy with respect to the commodity. Further, improved predictions of consumption/demand should provide benefit via positive economic and environmental impacts.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to managing and predicting a utility and more particularly to exploiting a joint utility predictor and controller for predicting a utility requirement, optionally transmitting the utility requirement to a utility provider, and managing consumption of the utility.

In accordance with an embodiment of the invention there is provided a method of establishing a commitment relating to a utility for a location comprising: employing acquired anonymised consumption data and ambient environment sensor data with associate time data as a training set for a machine based learning algorithm;
acquiring projected activity data and environmental data for a predetermined period of time in the future;
establishing using the machine based learning algorithm a planned utility consumption over the predetermined period of time for a plurality of time slots within the predetermined period of time.

In accordance with an embodiment of the invention there is provided a method of establishing control data for a controller controlling consumption of a utility for a location comprising:
employing acquired anonymised consumption data and ambient environment sensor data for a predetermined location with associated time data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing at least one control profile of a plurality of control profiles for the controller in dependence upon the planned utility consumption over the predetermined period of time for a plurality of time slots within the predetermined period of time for the predetermined location.

In accordance with an embodiment of the invention there is provided a method of establishing control data for a controller controlling consumption of a utility for a location comprising:
employing acquired consumption data and ambient environment sensor data for a predetermined location with associated time data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing at least one control profile of a plurality of control profiles for the controller in dependence upon the planned utility consumption over the predetermined period of time for a plurality of time slots within the predetermined period of time for the predetermined location.

In accordance with an embodiment of the invention there is provided a method comprising:
acquiring consumption data of at least one of a utility, a consumable, and a service for a predetermined location with associated time data as a training set for a machine based learning algorithm;
acquiring ambient environment sensor data for the predetermined location with associated time data;
employing the acquired consumption data and ambient environment data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing a plurality of control profiles for the controller in dependence upon the planned utility consumption over the predetermined period of time for a plurality of time slots within the predetermined period of time for the predetermined location, each control profile associated with a predetermined element within the predetermined location capable of consuming the at least one of the utility, the consumable, and the service; and
transmitting each control profile of the plurality of control profiles to its associated predetermined element.

In accordance with an embodiment of the invention there is provided a method comprising:
acquiring consumption data of at least one of a utility, a consumable, and a service for a predetermined location with associated time data as a training set for a machine based learning algorithm;
acquiring ambient environment sensor data for the predetermined location with associated time data;
employing the acquired consumption data and ambient environment data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location;
transmitting the planned utility consumption over the predetermined period of time for a plurality of time slots within the predetermined period of time for the predetermined location;
summing the planned utility consumptions for a predetermined plurality of predetermined locations to generate a cumulative planned utility consumption;
determining in dependence upon at least the cumulative planned utility consumption a control profile adjustment; and
transmitting the control profile adjustment to each controller of a physical element associated with each predetermined location of the predetermined plurality of predetermined locations capable of consuming the utility.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a joint utility predictor and controller (JUPAC) system according to an embodiment of the invention;

FIG. 2 depicts energy consumption predictions for a consumer established with a JUPAC according to an embodiment of the invention;

FIG. 3 depicts predicted energy consumption for a consumer predicted for the following 5 days with a JUPAC according to an embodiment of the invention;

FIG. 4 depicts an energy consumption hyperplane relating evolution of utility consumption with two inputs based upon a JUPAC according to an embodiment of the invention;

FIG. 5 depicts a network environment within which JUPAC's according to embodiments of the invention communicate; and

FIG. 6 depicts a JUPAC according to an embodiment of the invention.

### DETAILED DESCRIPTION

The present invention is directed to managing and predicting a utility and more particularly to exploiting a joint utility predictor and controller for predicting a utility requirement, optionally transmitting the utility requirement to a utility provider, and managing consumption of the utility.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a smart meter, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, a smart meter, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider”, “consumable provider” or “utility provider” as used herein may refer to, but is not limited to, a third-party provider of a service and/or a product to an enterprise and/or individual and/or group of individuals and/or a device comprising a microprocessor which can be metered and/or monitored to determine consumption/usage. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider. For ease of reference with the patent specification the term “utility provider” is employed but may refer to a provider of at least one of a utility, consumable, and service.

A “service”, “consumable” or “utility” as used herein may refer to, but is not limited to, a material which can be metered and/or monitored to determine consumption/usage either from a service provider to the consumer or from a consumer to a service provider. As such a service or utility may include, but not be limited to, electricity, natural gas, diesel, gasoline (petrol), water, data communications, wireless services, and sewage/waste. For ease of reference with the patent specification the term “utility” is employed but may refer to at least one of a utility, consumable, and service.

A “consumer” or “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user activity information, user scheduling information, and/or user profile information. It may also include one or more user diaries and/or calendars including, but not limited to, a personal agenda/diary/calendar, a family agenda/diary/calendar, and a business agenda/diary/calendar. It may also include, but not be limited to, a user's biometric information, an estimation of the user's biometric information, or a projection/prediction of a user's biometric information derived from current and/or historical biometric information. It may also include, but not be limited to, historical, current and future user travel information; historical, current, and predicted user location data; social media content generated and/or posted by the user; a historical, current, and future activity projection; user defined settings of other network interfaced equipment such as cable/satellite/digital set-top boxes, personal video recorders, Internet browsing data, data streaming data, etc.

“Auxiliary” information, as used herein may refer to, but not be limited to historical, current, and future environmental data such as temperature, wind, ambient light, etc.; temporal data such as time and date, geographic information such as longitude and latitude, and temporal characteristics of a location with respect to evolution of ambient environment factors in response to controlled adjustments to environmental control systems (e.g. ambient temperature lag in heating/cooling cycle with respect to set point or ambient light versus energy consumption for different lighting elements within a location). Auxiliary information may further include, tariffs relating to one or more utilities together with any temporal, day, season variations in the tariffs. For example, a furnace exploiting oil as a fuel will be approximately constant over a period of time with adjustments based upon the cost of refilling the tank(s) whilst electricity will typically have a daily cost pattern that is higher during so-called peak periods (e.g. 7 am-9 am or 4 pm-8 pm for example) and lower in so-called off-peak periods (e.g. 11 pm-5 am or 9 am-11:30 am for example) but changes weekdays to weekends.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

A “profile” as used herein, and throughout this disclosure, refers to a computer and/or microprocessor readable data file comprising data relating to settings and/or limits of an adult device. Such profiles may be established by a manufacturer of the adult device or established by an individual through a user interface to the adult device or a PED/FED in communication with the adult device.

A “location” as used herein, and throughout this disclosure, refers to a physical environment associated with a joint utility predictor and controller (JUPAC) wherein the location is that for which the JUPAC predicts, for example a utility requirement, and manages, e.g. consumption of the utility. Accordingly, a location may include, but not be limited to, a room, an apartment, a house, a store, a warehouse, a vehicle, a floor of a building, a building, a group of buildings, a neighborhood and town.

A: Ambient Parameters Collection

A joint utility predictor and controller (JUPAC) according to embodiments of the invention exploits embedded adaptive machine learning algorithms which exploit consumption/production information together with parameters relating to the consumer's environment (location). The consumer's environment may be established in dependence upon internal parameters and external parameters. In order to collect and determine indoor ambient parameters, the JUPAC device may exploit connectivity to one or more sensors such as temperature sensors, humidity sensors, ambient light sensors, Lux sensor, etc. as well as one or more controllers such as a lighting controller or HVAC controller for example. Collection of external ambient parameters may be made via the JUPAC device having connectivity to one or more external sensors such as temperature sensors, humidity sensors, ambient light sensors as well as external controllers although in other embodiments of the invention the JUPAC may derive external ambient parameters via one or more services such as world wide web (Internet) accessible weather services, consumer calendars, etc.

A JUPAC may also establish in embodiments of the invention multiple consumption/production models relating to equipment within the location being controlled/modelled. For example, a location may have a main central ceiling light and multiple distributed table/floor lamps such that different combinations may provide different lighting/consumption profiles with respect to providing light to a user within the location which also comprises a south facing window rather than an east facing window in another otherwise equivalent location. Optionally, a location may have a central furnace based HVAC together with floor based electric heaters. A JUPAC may also factor ambient temperature lag in heating/cooling cycle with respect to set point and measured sensor data to terminate a heating cycle prior to ambient temperature sensors indicating achievement of the target set point on the basis of prior cycles.

Within other embodiments of the invention the JUPAC device may prompt the user to define and/or label times as being occupied, unoccupied, active (e.g. awake), passive (e.g. sleeping), etc. and present the user with priority selections such as is humidity important in specific labelled times or are there times wherein the acceptable deviation of temperature from the target is higher than in others, e.g. during an unoccupied period during the day versus when the user is sleeping.

Within other embodiments of the invention the JUPAC device may characterise the location such as, for example, deriving time constants for heating and/or cooling, utility consumption for heating and/or cooling predetermined temperature changes, deriving time constants for humidification and/or dehumidification, utility consumption for humidification and/or dehumidification predetermined relative humidity offsets.

Within embodiments of the invention a JUPAC is described as employing one or more machine learning algorithms. These may be used discretely or in combination with one or more fixed algorithms and/or artificial intelligence.

Within embodiments of the invention the output of a JUPAC derived in dependence upon one or more machine learning algorithms, fixed algorithms, or artificial intelligence over a predetermined period of time for a predetermined location. It would be evident that the user information over this predetermined period of time may relate to a fixed set of users, e.g. the members of a family for their family home, or that it may relate to predetermined subsets of a known set of users, e.g. user in a day shift and a night shift within a manufacturing location or office staff during the daytime and cleaning/maintenance staff in the evening, or that the users may be varying. For example, a JUPAC may establish the control settings for a hotel room independence upon accessing the user's preferred settings from their residential JUPAC based upon establishing the appropriate authorizations, system identification etc.

Within other embodiments of the invention the JUPAC may employ an initial training phase similar to a conventional programmable controller or an adjustable controller to establish desired location environment data, e.g. the user(s) seek a first ambient environment upon waking up, a second ambient environment when relaxing (by correlating the ambient environment data to entertainment device activity), and seek a third ambient environment when sleeping. Accordingly, the JUPAC may dynamically establish the target ambient environment based upon an evolved historical profile adjusted in dependence upon one or more other data sources including, for example user information, auxiliary information, biometric data, and a profile.

For example, in a first scenario a schedule to turn on the heating and lights for a user at 15:00 hrs in December may be adjusted based upon a calendar entry that the user is currently in a meeting at a client, upon location data indicating that they are delayed in traffic and their estimated time of arrival is 16:10 hrs or that their location data indicates that they are travelling from their work location to their home early and hence the schedule advanced. Within embodiments of the invention an advancement or delay in a sequence of control may result in the consumption transitioning from one tariff rate to another. Accordingly, the control may be targeted to maintain target cost, target consumption, or target temperature. In controlling to target cost a JUPAC may adjust not only the on/off time but also the set-point so that, for example, the temperature set-point is raised by a determined amount when the JUPAC is controlling a cooling system based upon the external temperature to the location or in contrast lowered by a determined amount when the JUPAC is controlling a heating system. The determined amount may be established in dependence upon the JUPAC receiving not only ambient temperature information but utility consumption information so that the JUPAC may determine a cost profile for a particular control aspect.

The collected information could be directly consumed for the needs of the JUPAC device such as to adjust HVAC or to perform an accurate prediction for example or it may be used to infer other information like user behaviour, e.g. sleeping mode, travel, increased number of people, user cooking etc. The JUPAC device absent any other aspects at a default base level can ensure that its primary role of maintaining and controlling the environment associated with the consumer(s) and the JUPAC device such as by adjusting the various appliances, such as furnace, humidifier, air conditioner, electrically operated windows, etc., to reach a specific configuration of ambient parameters, e.g. temperature and humidity.

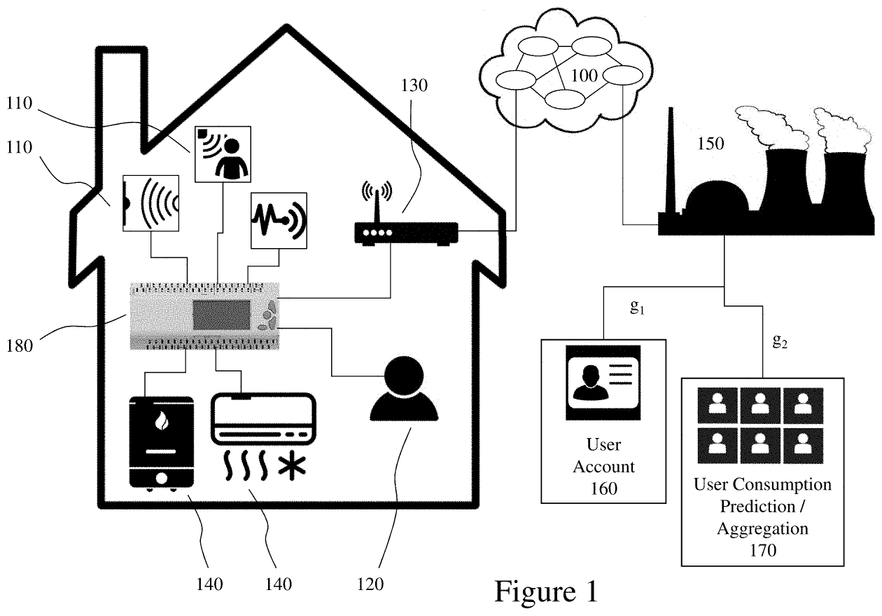

As depicted in FIG. 1 Sensors 110 communicate with the JUPAC 180 which then communicates with the Appliances 140 and the external world through Router 130, such as to Utility 150 wherein there is maintained a user account/profile 160 and a user consumption prediction/aggregation 170 comprising consumption predictions from the JUPAC 180 for each user associated with a JUPAC 180 to the Utility 150. The JUPAC 180 may receive input from the User 120 as well as data from the Utility 150 and provide control data to the Appliances 140.

Within embodiments of the invention the ambient parameter configuration could be specified by the User 120 or it may be automatically determined by the JUPAC 180 in dependence upon the sensors and/or appliances to which it is connected. The JUPAC 180 may make suggestions to users for improving its prediction accuracy through adding missing sensors or upgrading sensors, for example. Said sensors may include, but not be limited to, internal/external ambient environment sensors and utility consumption sensors.

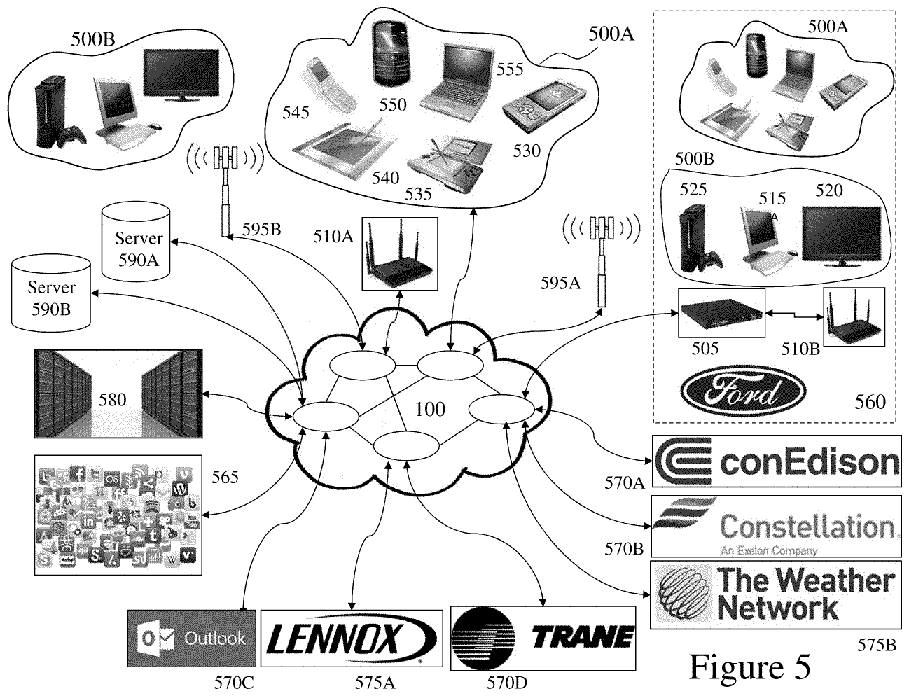

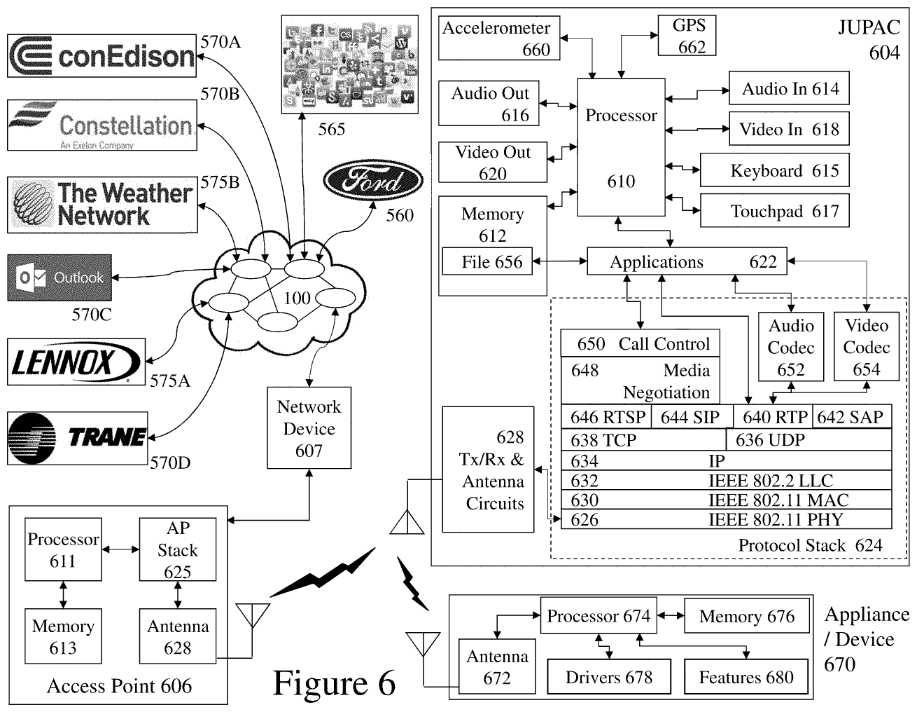

As depicted the JUPAC 180 is connected to the Internet 100 via a Router 130 as also described in more detail below in respect of FIGS. 5 and 6. The Router 130 allows the JUPAC 180 to web services that provide a range of external data that it cannot collect by its own sensors such as outdoor weather (unless these are provided), weather forecasts, access to user calendar(s)—diary—agenda—social media/social networks etc. Internet 100 access also allows the JUPAC 180 to send energy consumption commitments/projections to a specific software hosted by the energy provider (Utility 150 ) as well as receive updates to the JUPAC embedded software when necessary.

A.1. Machine Learning for Prediction

By collecting indoor, outdoor and behaviour usage data discretely or in conjunction with a training phase, the JUPAC device can learn and establish configurations for one or more appliances and appliance configurations which are related to each ambient parameter combination (indoor measurements, outdoor measurements and other useful data like energy consumer behaviour). Accordingly, the JUPAC device can use the predicted appliance configuration in conjunction with weather forecast, user activity data etc. to deduce the user's future energy consumption for a predetermined period into the future with a granularity defined by the utility, e.g. a week ahead with 2-hour granularity, 2 days forward with 1-hour granularity, next 3 days at 2-hour granularity and projected totals for subsequent 12 days. These may then be communicated to the utility either as a commitment for a predetermined period into the future or a forecast for a predetermined period of time. Optionally, the granularity may be variable such that the utility captures at a finer granularity during so-called peak consumption/generation periods than during so-called off-peak or low consumption periods. This granularity may also be defined by the ability of the utility to provide additional levels of the utility to its distribution grid etc. For example, electricity production capacity increases may have different lead times/availability based upon for example whether they are wind, nuclear, solar, fossil fueled etc. and whether it is daytime/nighttime etc.

To perform the energy consumption predictions, a JUPAC according to an embodiment of the invention exploits an embedded machine learning algorithm. Supposing that the commitment will be produced and sent each 24 hours and that this commitment will include the energy consumption prediction details during the entire next day, two days, week etc. The prediction granularity is by default fixed to one prediction each hour. It means that each commitment will include 24 predictions that cover the whole next day energy consumption. Indeed, the number of predictions per day could be different. It depends on the accuracy level requested by the energy supplier and the computing limits of the JUPAC device capacities. Optionally, the commitment may be firm for the next 24 hours, but not firm for the subsequent 24 hours etc. but the data for say next day, week, month may be provided for longer term projections for the utility provider.

As represented in Table 1 below, a training set may be organized on separate slots which each slot represents a unique daily hour. Those slots will be used as a training base for a set of regressions that will output a set of predictions related to each slot.

TABLE 1
Prediction System Learning Matrix

| | |
|---|---|
| Slot 0 | Slot S |

| X⁰ | | | Ŷ⁰ | X^{S} | | | Ŷ^{S} |
|---|---|---|---|---|---|---|---|
| x₀ | . . . | xᵢ | y₀ | x₀ | . . . | xᵢ | y₀ |
| x_{0, n} | . . . | x_{i, n} | yₙ | x_{0, n} | . . . | x_{i, n} | yₙ |

The inventors have employed multiple linear regression given that their regression model includes multiple regressor variables, see E. Peck et al. in “Introduction to Linear Regression Analysis” (J Wiley and Sons), i.e., for all s=1,2, . . . , as given by Equations (1) and (2) below.

$$\begin{matrix}{{Y}^{⋒}}^{S} = {{θ}^{⋒}}^{S} \cdot {X}^{S} & ( 1 ) \\ {{θ}^{⋒}}^{S} = arg {\sum }_{j = 1}^{S} {( {Y}^{j} - {X}^{j} \cdot ω )}^{2} & ( 2 )\end{matrix}$$

The entire slots predictions will represent the daily prediction that will be commuted as a commitment between the user and the energy supplier. It means that during a day, the machine learning will predict a set of Ŷ where Ŷ°={Ŷ⁰, . . . ,Ŷ^{s}} and s is the time slot identification. The training set consists of a consistent dataset composed of n records where each record is formed by a vector X which is paired with a value Y. Considering X as an input vector, Xᵢ={X₀ . . . Xᵢ} where each Xᵢ is an individual parameter collected by the JUPAC device. As regards Ŷ, it is collected by the energy supplier using, for example, a smart meter installed at the user location.

A.2. Prediction Driven Control

The JUPAC device will act as a controller by adjusting the user appliances with respect the predicted electricity usage communicated to the energy supplier in the commitment. The appliance control could also be managed based on the user preferences and the smart configuration that it builds based on user behaviour (sleeping mode, travel mode; outside mode; etc.). Optionally, the JUPAC will allow priority to user manual configurations in order to keep the user having the final control of their devices. Algorithm 1 below represents an exemplary consumption prediction and commitment algorithm according to an embodiment of the invention.

Algorithm 1: Future consumption prediction and commitment

```
Result: Energy supplier aggregate individual predictions to evaluate the global energy demand
initialization;
1. The JUPAC machine learning algorithm will use the configurations history and the ambient
records as a training base;
        for each day U do
            for each day D (example: Sept. 1st) do
            end
            for each time s (example: 13h00) do
                  1 After training, JUPAC provide an energy consumption prediction Ŷ_{S};
                  2 JUPAC add Ŷ_{S} to the vector Ŷ_{S} as part of the commitment Cₜ₊₁;
            end
      3.1 As soon as a commitment Cₜ₊₁ is completed, JUPAC display content in a user-
      friendly manner via graphical user interface (GUI) (Optional step);
      3.2 The user confirms the commitment Cₚ₊₁ (Optional step);
      4 The JUPAC device sends the commitment Cₚ₊₁ to the energy supplier;
      5 At Dᵢ, energy supplier will generate C_{d+1} energy consumption commitment;
      6 At D + 1 ;The JUPAC adjusts user' appliances in order the respect the energy
      consumption communicated in C_{d+1} ;
      7 At D + 1; energy supplier compares real energy consumption R_{d+1} with C_{d+1} to
      produce dr. dr measure how much the energy consumption prediction (already
      received) fits with the real consumption;
      8 In addition to R_{d+1}, supplier will use user dr rate to determinate the right charging
      formula or to calculate a fit over a predetermined period of time between the real and
      predicted energy consumption in order to establish a reward to be provided to the user
      when the fit falls within a predetermined set of limits established by the energy supplier;
      end
```

Optionally, the predetermined set of limits may be one of a plurality of predetermined sets of limits wherein the reward provider to the consumer/user is established in dependence upon which predetermined set of limits is met. For example, different sets of limits may be 10%, 5%, 2% and 1% with the reward inversely proportion to the set such that the reward for 1% is higher than the reward for 10%. Optionally, the predetermined set of limits may be established in dependence upon the utility, in dependence upon temporal data such that a reward is given for being within 2% of target during peak time and 5% during off-peak for example, etc.

A.3. The Energy Demand Prediction

Accordingly, the energy supplier will receive energy consumption commitments from its users, represented by g₁ in FIG. 1 as transmitted from the User Account 160 to Utility 150. It will aggregate those commitments _{Cd+l} in order to build a larger prediction concerning specific clusters of energy consumers like an energy consumer in some specific area. This aggregation will be performed by a software hosted by the energy supplier. In fact, thanks to the formatted structure of data provided through the user's commitments, the electricity demand can be predicted through a simple aggregation of the commitments records. Furthermore, energy supplier can perform a horizontal aggregation, i.e. aggregating all the energy consumption prediction records provided by different commitments in a specific area for a specific time. As a result, energy supplier could more easily predict the future activity of its electricity grid to determinate for example; how much turbines it has to activate, better estimates electricity demand in a specific geographic zone and improve renewable energy use thanks to more predictable energy demand. By exploiting the dr rate the energy supplier may reward a user based on the fitting level between the real and the predicted energy consumption, this being represented by g₂ between Utility 150 and User Consumption Predictions/Aggregation 170. Further, the closer the user's consumption is to the commitment C_{d+l} (predicted energy consumption) then the higher the reward might be. To encourage an energy consumer's adhesion, the commitment respecting rate will be used exclusively to reward the user. In case of non-respect, the user will pay the energy supplier with the regular pricing formula, he will only lose the reward. Alternatively, the consumption above the commitment may be charged at a higher rate as a penalty. Optionally, consumption lower than the commitment also leads to a reward and a more complicated reward scheme offered that incentivizes lower commitments and improved accuracy.

B. Simulation

For the experiment, the inventors used a public dataset provided by OpenEI (OpenEI.org—EPLUS TMY2 Residential Base) that includes 8760 data records collected in a regular way (each hour) and in a single residential location. Each data record includes energy consumption details like heat usage, electrical devices, etc. This dataset was used to train a machine learning algorithm in order to perform the energy consumption prediction. The data were ordered by time stamps and split into 24 slots where each one represents a unique daily hour, e.g. 13h00. The JUPAC machine learning algorithm runs a set of multiple linear regressions applied on each time slot. In terms of technology, the inventors employed the Statsmodels Python module to implement the multiple linear regression using an ordinary least squares method to perform the multiple linear regressions

B.1. Tests and Results

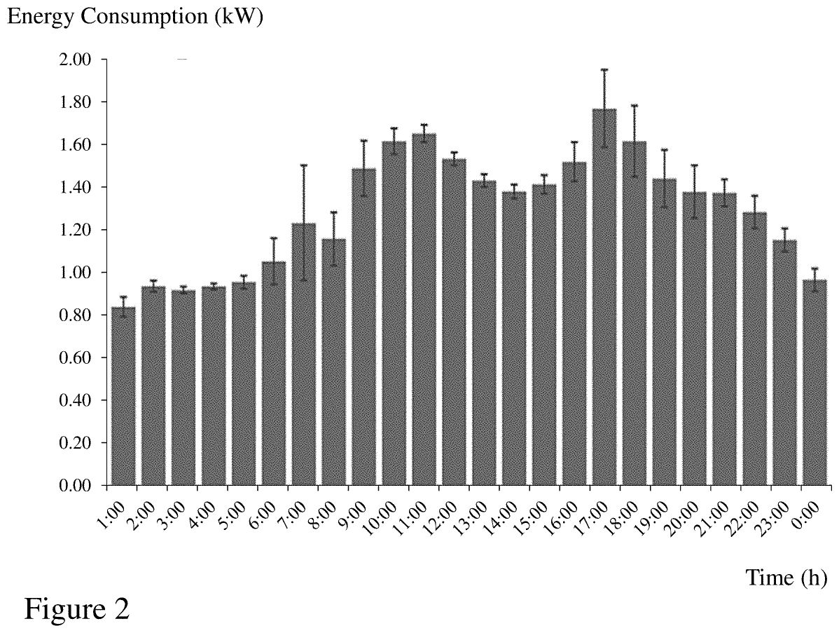

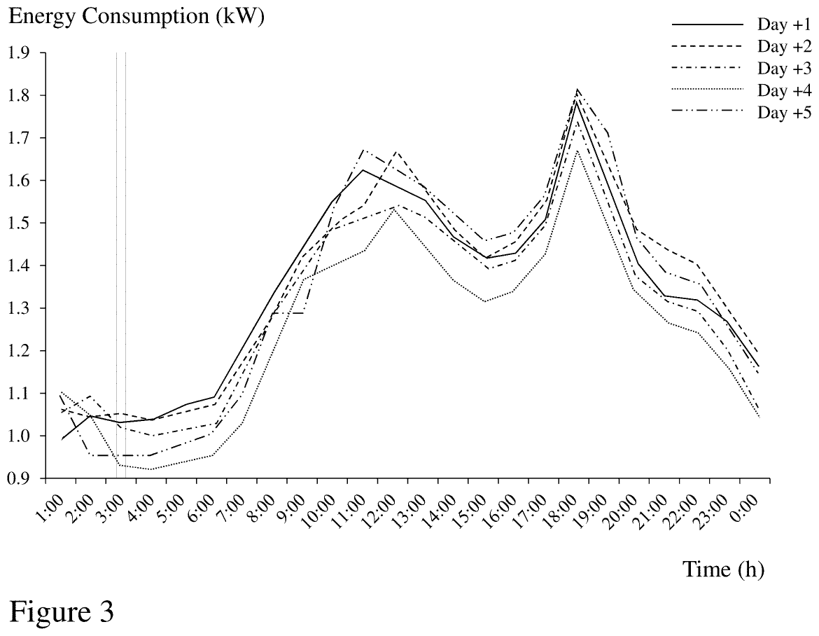

Once trained, the JUPAC machine learning algorithm was able the predict next day energy consumption details with an averaged error squared equal to 91.83% between all of the 24 time slots. In FIG. 2, the inventors have utilised error bar representation to visualize the predicted energy consumption during a day including the prediction errors (in comparison with real energy consumption for the same day). We have also to notice that the prediction accuracy was lower in a small number of time slots due the lack of data used for the simulation, in this case, it concerns the time slots 18:0, 19:00 and 20:00, as depicted in FIG. 2. This gap will be naturally filled once the training set “grows up”. Once a consistent training set is constituted, the JUPAC machine learning algorithm will be able to extend its prediction over one day as represented in FIG. 3. Finally, once the prediction is constituted, it could be sent to the energy supplier and will support the JUPAC controller to adjust better user devices' respecting the energy consumption commitment.

Whilst FIG. 3 depicts the JUPAC machine learning algorithm prediction over a period of 5 days it would be evident that the predictions may be made over different periods of time as well as the time slots over which the predictions are made may be varied within other instances of applying embodiments of the invention. It would be further evident that the time slots of the acquired consumption and/or environmental data for the training set may be different from those employed within the prediction.

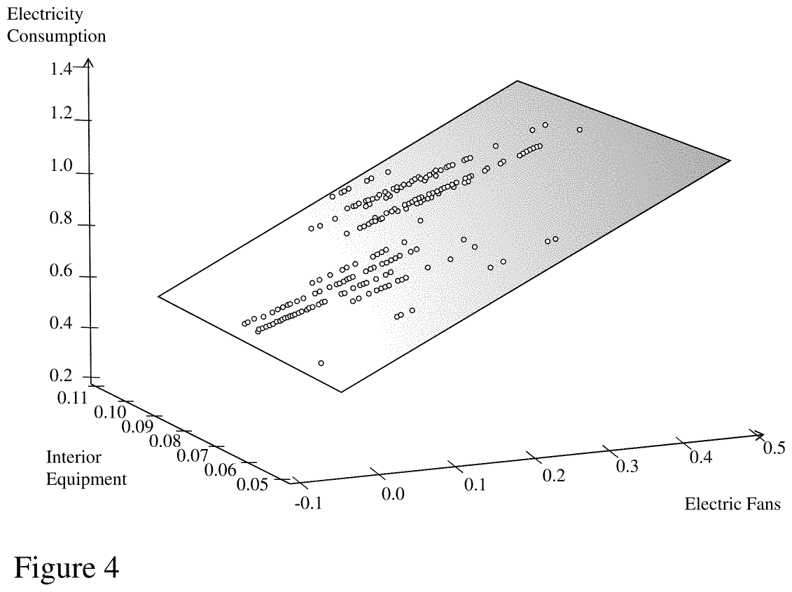

Now referring to FIG. 4 the inventors illustrate a hyper plane to demonstrate how energy consumption evolves depending on two inputs, namely interior electric equipment and electric fans. The hyper plane evolves from lower consumption at the lower front region to higher consumption at the rear. The inventors note that the model would generally exploit multiple inputs and hence that shown is for illustration. It would also be evident that the hyper plane may be a series of hyper planes representing the locations energy consumption versus the inputs for different time periods as a hyper plane for an environment during the winter may be different to that during the summer or that a hyper plane for weekends is different to weekdays for example for an office building.

Referring to FIG. 5 there is depicted a network environment 100 within which embodiments of the invention may be employed supporting JUPAC systems, applications, and platforms (JUSAPs) according to embodiments of the invention. Such JUSAPs, for example supporting multiple channels and dynamic content. As shown first and second user groups 500A and 500B respectively interface to a telecommunications network 100. Within the representative telecommunication architecture, a remote central exchange 580 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 580 is connected via the network 100 to local, regional, and international exchanges (not shown for clarity) and therein through network 100 to first and second cellular APs 595A and 595B respectively which provide Wi-Fi cells for first and second user groups 500A and 500B respectively. Also connected to the network 100 are first and second Wi-Fi nodes 510A and 510B, the latter of which being coupled to network 100 via cable modem/router 505. Second Wi-Fi node 510B is associated with Enterprise 560, such as Ford™ for example, within which other first and second user groups 500A and 500B are disposed. Second user group 500B may also be connected to the network 500 via wired interfaces including, but not limited to, DSL, Dial-Up, DOCSIS, Ethernet, G.hn, ISDN, MoCA, PON, and Power line communication (PLC) which may or may not be routed through a router such as cable modem/router 505.

Within the cell associated with first AP 510A the first group of users 500A may employ a variety of PEDs including for example, laptop computer 555, portable gaming console 535, tablet computer 540, smartphone 550, cellular telephone 545 as well as portable multimedia player 530. Within the cell associated with second AP 510B are the second group of users 500B which may employ a variety of FEDs including for example gaming console 525, personal computer 515 and wireless/Internet enabled television 520 as well as cable modem/router 505. First and second cellular APs 595A and 595B respectively provide, for example, cellular GSM (Global System for Mobile Communications) telephony services as well as 3G and 4G evolved services with enhanced data transport support. Second cellular AP 595B provides coverage in the exemplary embodiment to first and second user groups 500A and 500B. Alternatively the first and second user groups 500A and 500B may be geographically disparate and access the network 500 through multiple APs, not shown for clarity, distributed geographically by the network operator or operators. First cellular AP 595A as show provides coverage to first user group 500A and environment 570, which comprises second user group 500B as well as first user group 500A. Accordingly, the first and second user groups 500A and 500B may according to their particular communications interfaces communicate to the network 500 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 500A may form associations either through standards such as IEEE 802.15 and Bluetooth as well in an ad-hoc manner.

Also connected to the network 100 are Social Networks (SOCNETS) 565, first utility provider 570A, e.g. conEdison™; second utility provider 570B, e.g. Constellation™; online calendar 570C, e.g. Microsoft™ Outlook, air conditioner provider 575A, e.g. Lennox™; furnace manufacturer 570D, e.g. Trane™; and online weather resource 575B, e.g. The Weather Network and User 560; as well as first and second servers 590A and 590B which together with others, not shown for clarity. Accordingly, a user employing one or more JUSAPs may interact with one or more such providers, enterprises, service providers, retailers, third parties etc. and other users. First and second servers 590A and 590B may host according to embodiments of the inventions multiple services associated with a provider of JUPAC systems, applications, and platforms (JUSAPs); a provider of a SOCNET or Social Media (SOME) exploiting JUSAP features; a provider of a SOCNET and/or SOME not exploiting JUSAP features; a provider of services to PEDS and/or FEDS; a provider of one or more aspects of wired and/or wireless communications; an Enterprise 560 exploiting JUSAP features; license databases; content databases; image databases; content libraries; customer databases; websites; and software applications for download to or access by FEDs and/or PEDs exploiting and/or hosting JUSAP features. First and second primary content servers 590A and 590B may also host for example other Internet services such as a search engine, financial services, third party applications and other Internet based services.

Accordingly, a user may exploit a PED and/or FED within an Enterprise 560, for example, and access one of the first or second primary content servers 590A and 590B respectively to perform an operation such as accessing/downloading an application which provides JUSAP features according to embodiments of the invention; execute an application already installed providing JUSAP features; execute a web based application providing JUSAP features; or access content. Similarly, a user may undertake such actions or others exploiting embodiments of the invention exploiting a PED or FED within first and second user groups 500A and 500B respectively via one of first and second cellular APs 595A and 595B respectively and first Wi-Fi nodes 510A.

Now referring to FIG. 6 there is depicted a JUPAC 604 and network access point (AP) 606 supporting JUSAP features according to embodiments of the invention. JUPAC 604 may, for example, be a PED and/or FED and may include additional elements above and beyond those described and depicted. Also depicted within the JUPAC 604 is the protocol architecture as part of a simplified functional diagram of a system that includes an JUPAC 604, such as a smartphone 550, AP 606, such as first AP 510, and one or more network devices 607, such as communication servers, streaming media servers, and routers for example such as first and second servers 590A and 590B respectively. Network devices 607 may be coupled to AP 606 via any combination of networks, wired, wireless and/or optical communication links such as discussed above in respect of FIG. 5 as well as directly as indicated. Network devices 607 are coupled to network 100 and therein Social Networks (SOCNETS) 565, first utility provider 570A, e.g. conEdison™; second utility provider 570B, e.g. Constellation™; online calendar 570C, e.g. Microsoft™Outlook, air conditioner provider 575A, e.g. Lennox™; furnace manufacturer 570D, e.g. Trane™; and online weather resource 575B, e.g. The Weather Network and User 560.

The JUPAC 604 includes one or more processors 610 and a memory 612 coupled to processor(s) 610. AP 606 also includes one or more processors 611 and a memory 613 coupled to processor(s) 610. A non-exhaustive list of examples for any of processors 610 and 611 includes a central processing unit (CPU), a digital signal processor (DSP), a reduced instruction set computer (RISC), a complex instruction set computer (CISC) and the like. Furthermore, any of processors 610 and 611 may be part of application specific integrated circuits (ASICs) or may be a part of application specific standard products (ASSPs). A non-exhaustive list of examples for memories 612 and 613 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

JUPAC 604 may include an audio input element 614, for example a microphone, and an audio output element 616, for example, a speaker, coupled to any of processors 610. JUPAC 604 may include a video input element 618, for example, a video camera or camera, and a video output element 620, for example an LCD display, coupled to any of processors 610. JUPAC 604 also includes a keyboard 615 and touchpad 617 which may for example be a physical keyboard and touchpad allowing the user to enter content or select functions within one of more applications 622. Alternatively, the keyboard 615 and touchpad 617 may be predetermined regions of a touch sensitive element forming part of the display within the JUPAC 604. The one or more applications 622 that are typically stored in memory 612 and are executable by any combination of processors 610. JUPAC 604 also includes accelerometer 660 providing three-dimensional motion input to the process 610 and GPS 662 which provides geographical location information to processor 610.

JUPAC 604 includes a protocol stack 624 and AP 606 includes a communication stack 625. Within the system depicted in FIG. 6 a protocol stack 624 is shown as IEEE 802.11 protocol stack but alternatively may exploit other protocol stacks such as an Internet Engineering Task Force (IETF) multimedia protocol stack for example. Likewise, AP stack 625 exploits a protocol stack but is not expanded for clarity. Elements of protocol stack 624 and AP stack 625 may be implemented in any combination of software, firmware and/or hardware. Protocol stack 624 includes an IEEE 802.11-compatible PHY module 626 that is coupled to one or more Tx/Rx & Antenna Circuits 628, an IEEE 802.11-compatible MAC module 630 coupled to an IEEE 802.2-compatible LLC module 632. Protocol stack 624 includes a network layer IP module 634, a transport layer User Datagram Protocol (UDP) module 636 and a transport layer Transmission Control Protocol (TCP) module 638. Protocol stack 624 also includes a session layer Real Time Transport Protocol (RTP) module 640, a Session Announcement Protocol (SAP) module 642, a Session Initiation Protocol (SIP) module 644 and a Real Time Streaming Protocol (RTSP) module 646. Protocol stack 624 includes a presentation layer media negotiation module 648, a call control module 650, one or more audio codecs 652 and one or more video codecs 654. Applications 622 may be able to create maintain and/or terminate communication sessions with any of devices 607 by way of AP 606.

Typically, applications 622 may activate any of the SAP, SIP, RTSP, media negotiation and call control modules for that purpose. Typically, information may propagate from the SAP, SIP, RTSP, media negotiation and call control modules to PHY module 626 through TCP module 638, IP module 634, LLC module 632 and MAC module 630. It would be apparent to one skilled in the art that elements of the JUPAC 604 may also be implemented within the AP 606 including but not limited to one or more elements of the protocol stack 624, including for example an IEEE 802.11-compatible PHY module, an IEEE 802.11-compatible MAC module, and an IEEE 802.2-compatible LLC module 632. The AP 606 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed MASHUBs represented by JUPAC 604 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted is Appliance/Device (AP-DEV) 670 which is coupled to the JUPAC 604 through a wireless interface between Antenna 672 and Tx/Rx & Antenna Circuits 628 wherein the JUPAC 604 may support, for example, a national wireless standard such as GSM together with one or more local and/or personal area wireless protocols such as IEEE 802.11 a/b/g WiFi,

IEEE 802.16 WiMAX, and IEEE 802.15 Bluetooth for example. The Antenna 672 is connected to Processor 674 and therein to Memory 676, Drivers 678, and Features 680. Accordingly, the AP-DEV 670 may operate as standalone device with factory installed control routines accessed through an interface on the AP-DEV 670, not shown for clarity, or through an application in execution upon the JUPAC 604. Subsequently, as described below one or more of these control routines may be modified, amended, deleted etc. whilst other new control routines may be created, acquired, installed etc.

Accordingly, it would be evident to one skilled the art that the AP-DEV 670 with associated JUPAC 604 may accordingly download original software and/or revisions for a variety of functions supported by the drivers 678 and/or features 680. In some embodiments of the invention the functions may not be implemented within the original as sold AP-DEV 670 and are only activated through a software/firmware revision and/or upgrade either discretely or in combination with a subscription or subscription upgrade for example. Whilst the JUPAC 604, AP-DEV 670 and AP 606 are depicted exploiting wireless communications it would be evident that in other embodiments of the invention one or more of these wireless communication paths may be replaced with a wired connection or a non-wireless but unwired connection such as an optical link for example or not implemented and communications are through the AP 606 for example between AP-DEV 670 and JUPAC 604 or even via the network 100.

Accordingly, the JUPAC 604 may establish predictions of consumption based upon knowledge of user's consumption pattern combined with projections on environment, user activities etc. is then used in conjunction with utility price - time curve, pricing tariff thresholds for total consumption with predetermined periods and/or pricing tariffs based upon peak consumption are employed in managing consuming elements associated with the user through smart interfaces. Further the JUPAC 604 may access databases associated with installed appliances that are significant consumers of the utility, e.g. furnace, humidifier, dehumidifier, air conditioning, hot water tanks, etc., to establish control response surfaces for adjusting consumption in light of actual consumption based upon user activities and external environment.

Further, with user defined tolerances under different activity/use scenarios the appropriate response surface may be selected such that control is achieved with minimum discomfort and/or disruption to the user(s).

Further, in addition to major appliances control interfaces to secondary equipment and devices such as washing machines, dryers, ovens, etc. can be implemented in order to enable/disable their use under user control (e.g. a family cannot do laundry during the evening peak period but can in the afternoon or late evening). Alternatively, control interfaces to secondary equipment and devices can provide the JUPAC with control of when the washing machine executes a washing cycle rather than at the user's command such that the user can load the machine but the JUPAC determines when to run.

Within the embodiments of the invention described supra the service, consumable or utility has been primarily described in respect of utilities such as electricity. However, it would be evident that any service, consumable, or utility can be subjected to the methods, processes and systems described supra.

Within the embodiments of the invention described supra the service, consumable or utility has been primarily described in respect of consumption. However, it would be evident that the production of any service, consumable, or utility can be subjected to the methods, processes and systems described supra.

Within the embodiments of the invention described supra the service, consumable or utility has been primarily described in respect of consumption and/or production. However, it would be evident that the consumption and/or production of any service, consumable, or utility can be subjected to the methods, processes and systems described supra in order to adjust the consumption and/or production against a cost target or cost factor.

Within the embodiments of the invention described supra the service, consumable or utility has been primarily described in respect of consumption and/or production with the JUPAC exploiting machine learning algorithms. However, it would be evident that the consumption and/or production of any service, consumable, or utility can be subjected to the methods, processes and systems described supra in an iterative process with machine learning and/or artificial intelligence in order to adjust the consumption and/or production.

Within the embodiments of the invention described supra the service, consumable or utility the JUPAC may be centralized within a location, e.g. associated with a metering service of a utility, consumable or service, or it may be distributed (for example associated with each major consumption element of a utility, consumable or service). With a centralized JUPAC the communications back to a utility may be via one or more of wireless communications, wired communications, according to a predetermined standard communications protocol, and according to a bespoke or custom communications protocol. Similarly, with distributed JUPACs these may communicate to a utility or other service provider individually or through a central router/modem/interface module which may aggregate for the location or send all forecasts individually. A JUPAC may be associated with a single service, consumable or utility or it may be associated with multiple services, consumables or utilities or combinations thereof.

A JUPAC may directly establish at least one control profile or a plurality of control profiles for the controller of the item of equipment to which the JUPAC is associated wherein the control profile is established in dependence upon the planned utility consumption over the predetermined period of time that the JUPAC establishes the planned utility consumption over using the machine based learning algorithm or other methods.

The JUPAC may alternatively establish a plurality of control profiles where each control profile rather than being associated with a single controller for a common item of equipment is associated with a controller for a different item of equipment. Depending upon the complexity of the JUPAC the JUPAC may establish the planned utility consumption for a single utility, service, or consumable or alternatively it may relate to multiple utilities, services, or consumables. The JUPAC may employ a common set of machine based learning algorithms or may employ multiple machine based learning algorithm sets each targeted to a different utility, service, or consumable or different item of equipment or subsets of a set of equipment. Accordingly, a JUPAC may establish control profiles for a natural gas based furnace, an electric hot water system, an exterior driveway de-icing system (electrical), interior lights, and a humidifier.

Within an alternate embodiment of the invention the acquired data from a location is pushed to a remote server, e.g. a utility's server, or a third-party server, wherein the remote server sums the planned utility consumptions for a predetermined plurality of predetermined locations to generate a cumulative planned utility consumption. Then in dependence upon at least the cumulative planned utility consumption a control profile adjustment is established which is then transmitted to each controller of a physical element associated with each predetermined location of the predetermined plurality of predetermined locations capable of consuming the utility. The predetermined plurality of predetermined locations may be a series of rooms forming a residence, a series of floors to an office building, a residential neighbourhood, a ward, a village, industrial complex, mall, etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof. Databases as referred to herein may also refer to digital repositories of content or other digitally stored content within a collection which may be indexed or non-indexed.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method of establishing a commitment relating to a utility for a location comprising: employing acquired anonymised consumption data and ambient environment sensor data for a predetermined location with associated time data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location.

2. The method according to claim 1, further comprising
at least one of:
adjusting the planned utility consumption over the predetermined period of time for a plurality of time slots within the predetermined period of time for the predetermined location to meet a predetermined criterion, the predetermined criterion being selected from the group comprising a measure of the utility consumption, a measure of the utility production, a measure of the cost of the utility consumption, and a measure of the cost of the utility production; and
establishing at least one control profile of a plurality of control profiles in dependence upon the planned utility consumption over the predetermined period of time for a plurality of time slots within the predetermined period of time for the predetermined location.

3. (canceled)

4. The method according to claim 1, further comprising
establishing at least one control profile of a plurality of control profiles in dependence upon the planned utility consumption over the predetermined period of time for a plurality of time slots within the predetermined period of time for the predetermined location; and
dynamically adjusting the at least one control profile of the plurality of control profiles in dependence upon at least an information item of a plurality of information items at a predetermined time, each information item relating to at least one of user information relating to a user of the predetermined location at the predetermined time, biometric information relating to a user of the predetermined location at the predetermined time;
and auxiliary information relating to the predetermined location at the predetermined time.

5. The method according to claim 1, further comprising
at least one of:
summing the planned consumption for a predetermined portion of the predetermined period of time to establish the commitment for the utility; and
monitoring for a portion of the predetermined period of time the actual consumption versus planned consumption and adjusting one or more control settings relating to one or more consumption devices of the utility in dependence upon at least the actual consumption and the planned consumption.

6. (canceled)

7. The method according to claim 1, wherein
at least one of:
the projected activity data is acquired from at least one of an agenda, a diary, a calendar and a social network for a user associated with the predetermined location: and
the environmental data is acquired from at least one of a user associated with the location and an online service provider.

8. (canceled)

9. The method according to claim 1, further comprising
incentivizing a user associated with the location to provide the planned utility consumption to a provider of the utility.

10. The method according to claim 1, further comprising
monitoring for a portion of the predetermined period of time the actual consumption versus planned consumption;
determining whether the actual consumption is within a set of predetermined limits of a plurality of sets of predetermined limits of the planned consumption;
rewarding the consumer in dependence upon the set of predetermined limits met.

11. The method according to claim 10, wherein
the set of predetermined limits are established in dependence upon at least one of the utility and temporal data.

12. A method of establishing control data for a controllerlling consumption of a utility for a location comprising:
employing acquired anonymised consumption data and ambient environment sensor data for a predetermined location with associated time data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing at least one control profile of a plurality of control profiles for the controller in dependence upon the planned utility consumption over the predetermined period of time for a plurality of time slots within the predetermined period of time for the predetermined location.

13. The method according to claim 12, further comprising
adjusting the planned utility consumption over the predetermined period of time for a plurality of time slots within the predetermined period of time for the predetermined location to meet a predetermined criterion, the predetermined criterion being selected from the group comprising a measure of the utility consumption, a measure of the utility production, a measure of the cost of the utility consumption, and a measure of the cost of the utility production.

14. The method according to claim 12, further comprising
dynamically adjusting the at least one control profile of the plurality of control profiles in dependence upon at least an information item of a plurality of information items at a predetermined time, each information item relating to at least one of user information relating to a user of the predetermined location at the predetermined time, biometric information relating to a user of the predetermined location at the predetermined time; and auxiliary information relating to the predetermined location at the predetermined time.

15. The method according to claim 1, further comprising
monitoring for a portion of the predetermined period of time the actual consumption versus planned consumption; and
adjusting one or more control settings relating to the control profile of the plurality of control profiles in dependence upon at least the actual consumption and the planned consumption.

16. The method according to claim 12, wherein
at least one of:
the projected activity data is acquired from at least one of an agenda, a diary, a calendar and a social network for a user associated with the predetermined location; and
the environmental data is acquired from at least one of a user associated with the location and an online service provider.

17. (canceled)

18. The method according to claim 12, further comprising at least one of:
incentivizing a user associated with the location to provide the planned utility consumption to a provider of the utility; and,
monitoring for a portion of the predetermined period of time the actual consumption versus planned consumption to determine whether the actual consumption is within a set of predetermined limits of a plurality of sets of predetermined limits of the planned consumption and rewarding the consumer in dependence upon the set of predetermined limits met.

19. (canceled)

20. The method according to claim 19, wherein
the set of predetermined limits are established in dependence upon at least one of the utility and temporal data.

21. The method according to claim 25; wherein
the process comprises:
employing acquired consumption data and ambient environment sensor data for a predetermined location with associated time data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing the control data comprises establishing at least one control profile of a plurality of control profiles for the controller in dependence upon the planned utility consumption over the predetermined period of time for a plurality of time slots within the predetermined period of time for the predetermined location.

22. The method according to claim 25; wherein
the process comprises:
acquiring consumption data of at least one of a utility, a consumable, and a service for a predetermined location with associated time data as a training set for a machine based learning algorithm;
acquiring ambient environment sensor data for the predetermined location with associated time data;
employing the acquired consumption data and ambient environment data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location; and
establishing the control data comprises:
establishing a plurality of control profiles for the controller in dependence upon the planned utility consumption over the predetermined period of time for a plurality of time slots within the predetermined period of time for the predetermined location, each control profile associated with a predetermined element within the predetermined location capable of consuming the at least one of the utility, the consumable, and the service; and
transmitting each control profile of the plurality of control profiles to its associated predetermined element.

23. The method according to claim 25; wherein
the process comprises:
acquiring consumption data of at least one of a utility, a consumable, and a service for a predetermined location with associated time data as a training set for a machine based learning algorithm;
acquiring ambient environment sensor data for the predetermined location with associated time data;
employing the acquired consumption data and ambient environment data as a training set for a machine based learning algorithm;
acquiring projected activity data and environmental data for the predetermined location for a predetermined period of time in the future;
establishing using the machine based learning algorithm a planned utility consumption over the predetermined period of time for a plurality of time slots within the predetermined period of time for the predetermined location;
transmitting the planned utility consumption over the predetermined period of time for a plurality of time slots within the predetermined period of time for the predetermined location;
summing the planned utility consumptions for a predetermined plurality of predetermined locations to generate a cumulative planned utility consumption; and
establishing the control data comprises:
determining in dependence upon at least the cumulative planned utility consumption a control profile adjustment; and
transmitting the control profile adjustment to each controller of a physical element associated with each predetermined location of the predetermined plurality of predetermined locations capable of consuming the utility.

24. The method according to claim 23, wherein
the control profile adjustment is employed by each controller to adjust a control profile of the physical element.

25. A method of establishing control data for a controller controlling consumption of a utility for a location comprising:
executing a process upon a microprocessor; and
establishing the control data.
